(19) United States
(12) Patent Application Publication
(10) Pub. No.: US 2005/0018197 A1
(43) Pub. Date: Jan. 27, 2005

(54) Spectral analysis system

(76) Inventor: Josh N. Hogan, Los Altos, CA (US)

Correspondence Address: Josh Hogan, 620 Kingswood Way, Los Altos, CA, 94022, US

(21) Appl. No.: 10/896,276

(22) Filed: Jul. 21, 2004

Related U.S. Application Data
(60) Provisional application No. 60/489,055, filed on Jul. 22, 2003.

(51) Int. Cl. G01J 3/45

(52) U.S. Cl. 356/451

(57) ABSTRACT

A spectral analysis system includes a signal processing system which provides a probe and a reference beam. The probe beam is applied to the target to be analyzed. The relative phase relationship of the two beams is varied. A scattered or transmitted portion of the probe beam is combined with the reference beam and a resulting interferometric signal is detected. An electronic processing and control system separates the spectral information in the electronic domain, processes the information and controls the system.

### CROSS REFERENCES TO RELATED APPLICATIONS

This application, docket number JH22030722, claims priority from provisional application Ser. No. 60/489,055 filed on July 22 th, 2003.

### RELATED APPLICATIONS

This invention relates to utility application entitled “A Non-invasive Analysis System”, Ser. No. 10/870,121 filed by Josh Hogan on July 17th., 2004, the contents of which are incorporated by reference as if fully set forth herein. This invention also relates to utility application entitled “A Real Time Imaging and Analysis System”, Ser. No. 10/870,120 filed by Josh Hogan on July 17th., 2004, the contents of which are incorporated by reference as if fully set forth herein.

### FIELD OF INVENTION

The invention relates to spectral analysis and in particular to optical spectral analysis.

### BACKGROUND OF THE INVENTION

In a typical optical spectral analysis system a broadband optical signal, referred to as a probe signal, is applied to a target. Part of the optical signal is absorbed by the material in the target. The magnitude of absorption may be different for different wavelengths contained within the broadband signal. The unabsorbed signal is transmitted, reflected or scattered by material in the target, referred to as a returned signal.

One or more of these returned signals is then separated into its different wavelengths in the optical domain, for example, by means of a diffraction grating. The intensity of each wavelength is then detected by means of an array of opto-electronic detectors, or a scanning mechanism is used to detect the intensity of each wavelength in sequence.

Separating the wavelengths in the optical domain typically involves a considerable path length to convert a small angular separation into a reasonable spatial separation. This and the associated optical components limit the compactness of the device and involve undesirable alignment and stability issues. Scanning mechanisms are typically electromechanical based technologies, such as galvanometers or moving coils actuators all have undesirable moving parts, are physically large and also have significant alignment and stability issues.

Scanning can also be achieved by acousto-optic scanning where an optical beam is deviated by a chirped acoustic wave propagating through a crystal. The acoustic wave is generated by applying an RF signal to the crystal by means of a transducer. The RF signal has a repetitive and linearly varying frequency which provides a matching linearly varying frequency (chirp) to the acoustic wave. The acoustic wave intercepts the optical wave and deviates it by an angle proportional to the RF frequency. This technique, however, is expensive, requires significant RF power and since the angular deviation is small and the system is physically large.

One or more of these aspects of moving parts, high cost components, high power consumption and large physical size make existing scanning spectral analysis systems unsuitable for cost effective, compact, robust, spectral analysis systems.

A spectral analysis systems are sometimes combined with sub-surface imaging or analysis technology, such as confocal microscopy, to generate tomographic images, for example, of tissue, containing information similar to biopsy sections by scanning a one dimensional array, parallel to the surface of the tissue (x-scan), at varying depths (z-scan) in tissues. The series one dimensional scans at various depths can be displayed as a single tomographic image. Such imaging or analysis systems, however, also have many of the undesirable aspects described above, making the combined spectral and imaging analysis system even more unsuitable for cost effective, compact, robust, spectral and imaging analysis systems.

Another sub-surface imaging technology, optical coherence tomography, can also generate tomographic, biopsy like images. Such systems use a Super-luminescence diode (SLD) as the optical source. The SLD output beam has a broad bandwidth and short coherence length. Optical coherence tomography involves splitting the output beam into a probe and reference beam. The probe beam is applied to the system to be analyzed (the target). Light scattered or reflected back from the target is combined with the reference beam to form the measurement signal.

Because of the short coherence length only light that is scattered from a depth within the target such that the total optical path lengths of the probe and reference are equal combine interferometrically. Thus the interferometric signal provides a measurement of the scattering value at a particular depth within the target. By varying the length of the reference path length, a measurement of the scattering values at various depths can be measured and in this manner, the z-axis can be scanned. The reference path length is typically varied by physically moving a reflecting mirror.

In order to get the biopsy like image, the second dimension scan, the x-scan is obtained by translating the probe focusing mirror parallel to the target surface. However, at least some of the above mentioned limitations apply to this imaging method also and, in general, these limitations represent a barrier to applying current imaging technologies to compact, cost effective real-time applications.

Such optical coherence tomography systems, however, also have many of the undesirable aspects described above, making the combined spectral and imaging analysis system even more unsuitable for cost effective, compact, robust, spectral and imaging analysis systems.

There is therefore an unmet need for a cost effective, compact, robust, spectral analysis system that has no moving parts and is compatible with imaging or analysis systems.

### SUMMARY OF THE INVENTION

The invention is a method, apparatus and system for a spectral analysis system. The invention includes a signal processing system which provides a probe and a reference beam, applying the probe beam to the target to be analyzed It includes varying the relative phase relationship of the two beams. It includes combining a scattered or transmitted portion of the probe beam with the reference beam and detecting an interferometric signal. It further includes an electronic processing and control system that separates the spectral information in the electronic domain, processes the information and controls the system.

### BRIEF DESCRIPTION OF THE DRAWINGS

FIG. 1 is an illustration of the spectral analysis system according to the invention.

FIG. 2 is an illustration of a preferred embodiment of the invention.

FIG. 3 is a frequency domain illustration of an output of a mode locked laser optical source.

FIG. 4 is a time domain illustration of the outputs of mode locked laser optical sources.

FIG. 5 is a frequency domain illustration of outputs of two mode locked laser optical sources.

FIG. 6 is an illustration of an electronic filtering system.

FIG. 7 is an illustration of an alternate embodiment of the invention.

FIG. 8 is an frequency domain illustration of the outputs of mode locked laser sources.

FIG. 9 is an illustration of an alternate electronic filtering system.

### DETAILED DESCRIPTION OF THE INVENTION

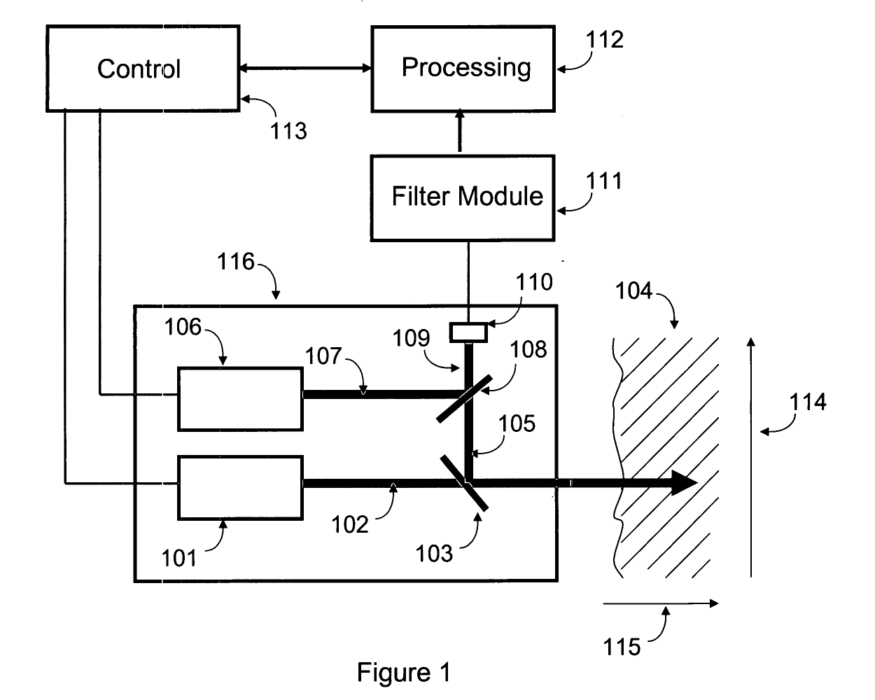

A novel spectral analysis system is illustrated in and described with reference to FIG. 1, where a compact spectral analysis system is shown. It includes two generators 101 and 106, that generate a repetitive signals. Each repetitive signal is a set of repetitive discrete coherent signals. Because all signals generated are coherent and have a repetitive determined phase relationship with each other, it is possible to combine these signals interferometrically to produce a signal that is related to the relative phase of the two sets of signals.

The repetitive frequency of the two generators 101 and 106 are offset from each other, by an low offset frequency, which causes corresponding individual coherent signals from the two sets of repetitive discrete coherent signals to be offset from each other by integral multiples of the low offset frequency. Additionally the two sets of repetitive discrete coherent signals can be offset from each other by a high offset frequency that is substantially the same for all corresponding individual coherent signals.

As illustrated in FIG. 1, the first generator 101 outputs a set of discrete coherent signals, referred to as a probe repetitive signal 102 that is applied to a target 104 to be analyzed. At least part of the probe repetitive signal applied to the target is reflected or scattered back and redirected by a signal steering element 103 to a signal combining element 108.

The part of the probe repetitive signal directed by the steering element to the combining element is referred to as the captured returned signal or the returned signal 105. Because the strength of the signal reflected or scattered back from any point in the target is dependent on the characteristics of the target at that point, this returned signal contains information relating to the target at that point.

The second generator 106 outputs a second set of discrete coherent signals referred to as a reference repetitive signal 107. This reference repetitive signal constitutes a reference signal and is also applied to the signal combining element 108 where it is combined interferometrically with the captured signal. The resulting interferometric signal 109 is detected by a detector 110.

The detected signal is filtered by an electronic filtering module 111 which separates the detected signal into multiple channels. The individual filter channels are related to the low and high frequency offsets. The high frequency offset may be zero, however non zero offset enables multiple pairs of sets of repetitive signals. The first filter channel is centered on a frequency equal to the high frequency offset. The second filter channel is centered on a frequency equal to the high frequency offset plus the low frequency offset. The third filter channel is centered on a frequency equal to the high frequency offset plus twice the low frequency offset, and so on. In general, a filter channel is centered on a frequency equal to the high frequency offset plus an integer times the low frequency offset.

A filter module is designed so that only the detected interferometric signal from a single pair of corresponding coherent signals is passed through each filter. The filter module may be comprised of digital or analog filters. They may be a set of parallel filters or alternatively a single filter whose center frequency and other parameters are programmable.

The filtered signal or signals output from the filter module, is processed in the processing module 112 in conjunction with timing signals from the control module 113, which also controls repetitive signal generators 101 and 106. The resulting information constitutes a spectral scan of a segment of the target along the depth or horizontal axis 115 of the target. This process can be repeated at different locations along an axis orthogonal to the horizontal axis, referred to as the vertical axis 114. This can be accomplished by translating the entire sub-system included in the box 116.

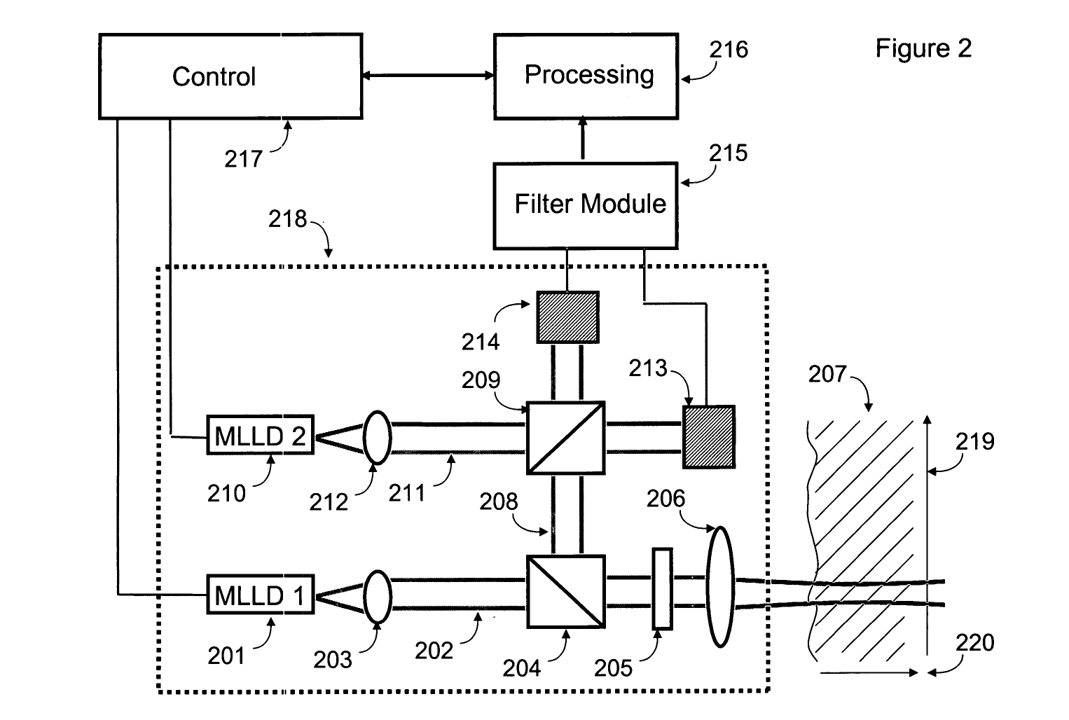

A preferred embodiment of the invention is illustrated in and described with reference to FIG. 2 where an optical spectral analysis system is shown. The system includes a first electronically pumped and mode locked laser diode 201, whose output 202, herein referred to as a probe repetitive signal, consists of a broad band set of wavelengths or modes, that have a repetitive phase relationship with each other, is collimated by a lens 203.

The output beam 202, is passed through a beam splitter 204, such as a polarization beam splitter, through a quarter wave plate 205, and a lens 206, with a relatively long Rayleigh range, e.g. 1 mm, and focused in a target 207. At least part of the optical signal applied to the target is reflected or scattered back and captured by the lens 206. It passes through the quarter wave plate 205, back to the beam-splitter 204, where at least part of it 208 is directed to the beam-splitter 209. The part of the captured returned signal 208 is also referred to as the returned signal. Reflection or scattering occurs because of material properties, discontinuities, such as changes of material properties, defects or changes of refractive index.

A second electronically mode locked laser diode 210, whose output 211, referred to as a reference signal, is collimated by a lens 212 and is also applied to the beam splitter 209, where it is combined interferometrically with the returned signal 208. The resulting interference signals are detected by opto-electronic detectors 213 and 214.

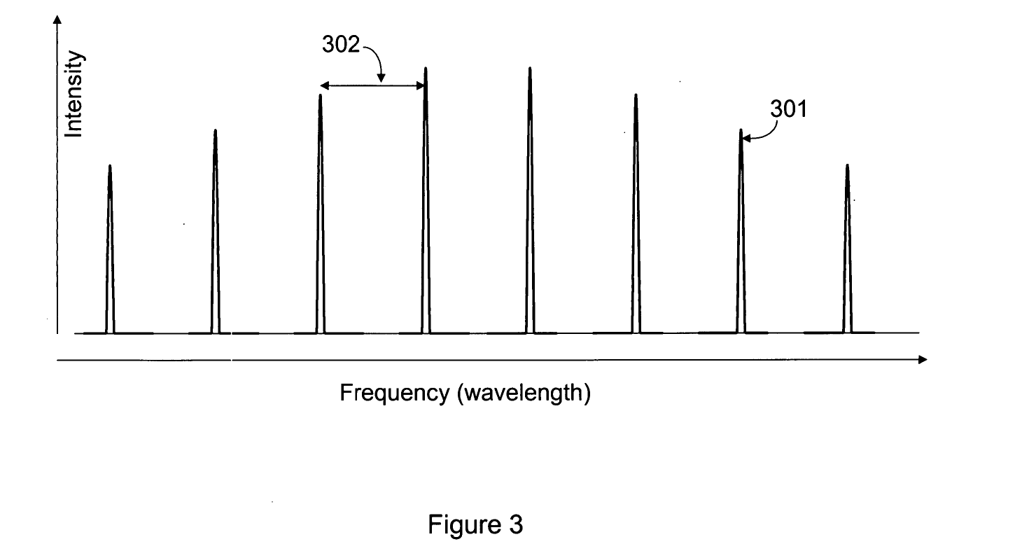

The detected interference signals are filtered by the filter module 215. The function of the filter module can be understood with respect to the signals generated by the mode locked lasers 201 and 210. A typical output is illustrated in the frequency domain in FIG. 3 and consists of a set of modes or wavelengths, one of which is 301, is shown. The wavelengths are separated from each other by a constant frequency difference 302. This frequency difference (delta_F) is related to the length of the laser diode according to the relationship delta_F=c/(2 nL) where c is the speed of light, n is the refractive index of the lasing material and L is the length of the laser diode cavity.

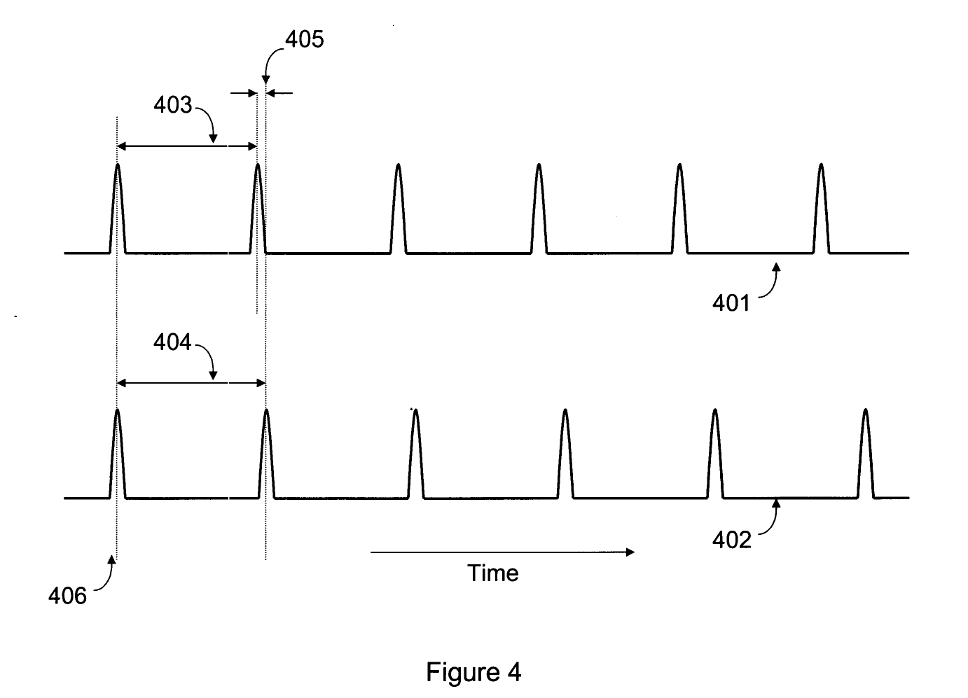

Mode locking is achieved by modulating the laser diode at a frequency equal to or harmonically related to the frequency delta_F. The output of the laser diode 201, of FIG. 2, referred to as the probe repetitive optical signal, is illustrated in the time domain in FIG. 4, where it is shown as a pulse train 401 with a repetition period 403, (T1) which is the reciprocal of its repetition frequency delta_F1. The output of the second laser diode 210, of FIG. 2, referred to as the reference repetitive optical signal, is shown as the pulse train 402 with a repetition period 404, (T2) which is the reciprocal of its frequency delta_F2.

The difference between the two periods 405 corresponds to the difference between the two frequencies delta_F 1 and delta_F2 and is referred to as a low frequency offset. Pulses from the two pulse trains go from being aligned in time, as shown at point 406, to a systematic increase in misalignment until they come back into alignment. The frequency with which pulses come back into alignment is related to the low frequency offset. The actual temporal relative alignment of the two pulse trains is referred to as their coherence phase relationship.

When the returned signal 208 is combined with the reference signal 211, an interference signal will only exist when the captured signal is substantially aligned in time with the reference pulse. Since the reference and captured signals have different pulse frequencies, at any given time, this alignment will correspond to only the optical signal reflected or scattered from a particular depth in the target.

Thus having a frequency offset between the reference and probe signals has the effect of selectively discriminating in favor of detecting a signal reflected or scattered from different depths in the target at different times. This effectively provides an electronic method of scanning in depth (or along the horizontal axis), with the advantage of having no moving parts. The range of the depth or horizontal axis scan corresponds to the optical path length of the laser cavity and a full scan occurs with a frequency corresponding to the low frequency offset 405.

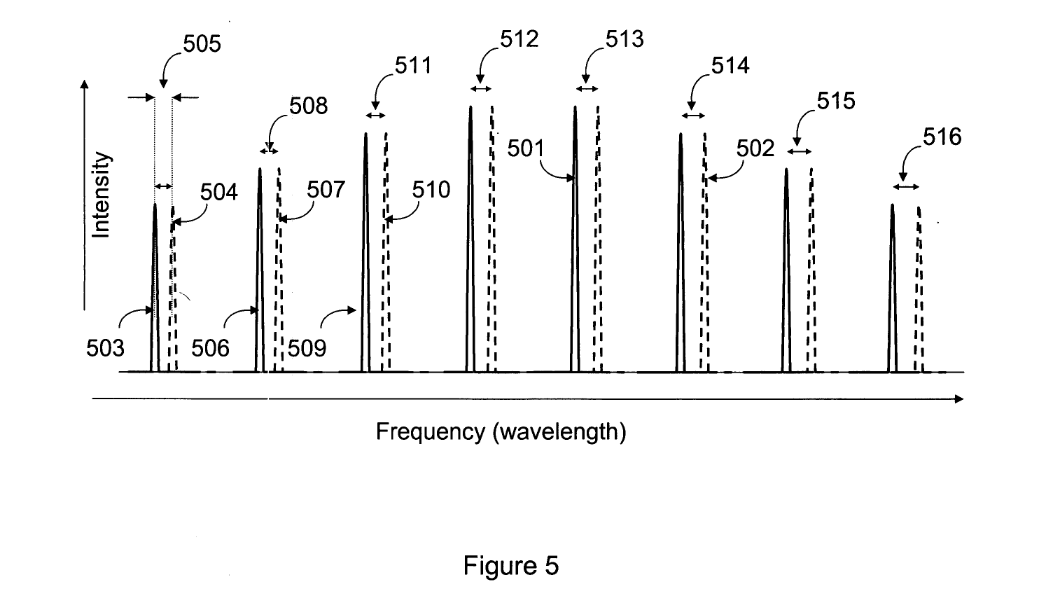

The two sets of wavelengths output by the two mode locked lasers 201 and 210 of FIG. 2 are illustrated in FIG. 5. One set is illustrated in solid lines, one wavelength of which is 501. The second set is in dashed lines, one wavelength of which is 502. The first pair of corresponding wavelength 503 and 504 of the two sets are separated by a high frequency offset 505. The second pair of corresponding wavelength 506 and 507 of the two sets are separated by a frequency 508 equal to the high frequency offset plus the low frequency offset 405 of FIG. 4. The third pair of corresponding wavelength 509 and 510 of the two sets are separated by a frequency 511 equal to the high frequency offset plus twice the low frequency offset 405 of FIG. 4. Similarly offsets 512, 513, 514, 515 and 516 all increase in magnitude by one times the low frequency offset.

An example of suitable frequency magnitude would be a mode (or wavelength) frequency spacing 302 of 10 GHz, corresponding to a mode locked pulse repetition rate of 10 GHz for the probe mode locked laser 201 and frequency spacing of 10.005 GHz for the reference mode locked laser 210, which results in a low frequency offset 405 of 5 MHz. A suitable high frequency offset 505 would be 2 GHz. This example would have the center frequency of adjacent filters offset from each other by 5 MHz.

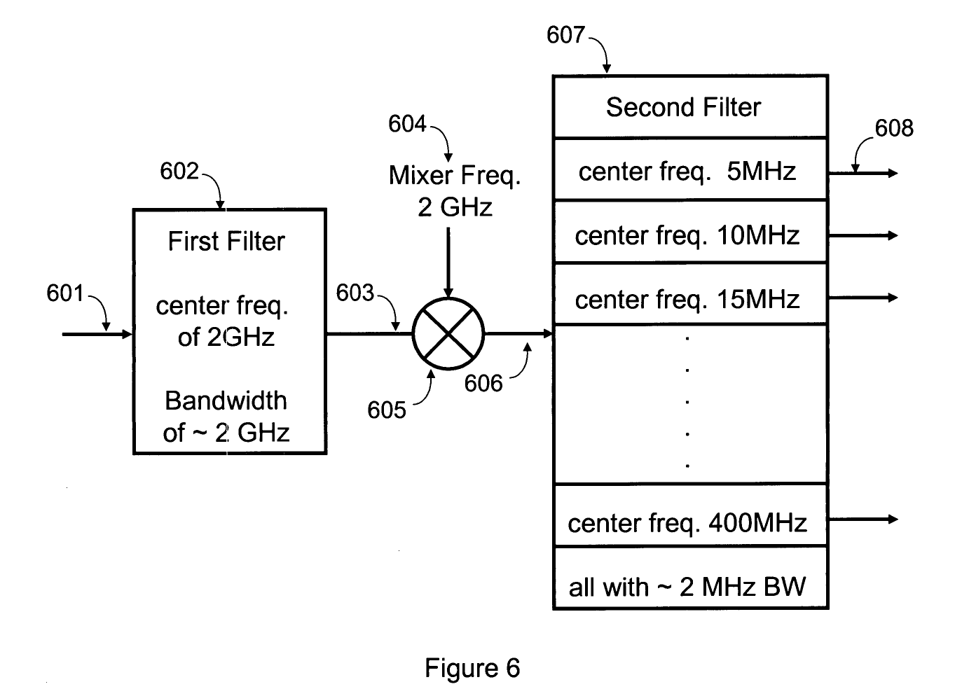

An example of a possible filter arrangement is illustrated in FIG. 6, where the detected interference signal 601 is applied to first filter centered on 2 GHz and with a bandwidth of the order of 2 GHz. The output 603 is mixed with a reference signal 604, such as a 2 GHz signal, in an electronic mixer 605, to produce a base band signal 606 which is applied to a second filter 607. The second filter consists of a bank of filters all with a bandwidth of the order of 2 MHz, but each centered on frequencies offset by 5 MHz from adjacent filters.

The outputs of the filters, the first of which being 608, are electronically processed by an electronic processing module 216 of FIG. 2. An electronic control module 217 controls the mode locked operation of the laser diodes 201 and 210 and also provides timing information to the processing module 215. The processing module combines this timing information with the detected filtered interference signals to compute a spectral profile of the target along the direction of the probe repetitive optical signal, which constitutes a one dimensional spectral scan of the target.

The optical components, 201, 203, 204, 205, 206, 109, 210, 212, 213 and 214, enclosed by the dashed box 218 in FIG. 2, do not involve any moving parts and can be assembled in a compact manner on an optical micro-bench facilitating vertical axis scanning with conventional electromechanical techniques. This optical system 218 of FIG. 2 can then be translated in a direction 219, perpendicular to the horizontal axis 220, by conventional electromechanical techniques, to provide a two dimensional spectral analysis of the target.

The control module 217, along with the processing module 216, can combine successive one dimensional spectral scans to generate a two dimensional scan. The control module 217 can also stores the scans and control parameters in non-volatile memory for display, for further analysis and future operation. Performing the spectral analysis in the electronic domain, along with the electronic scanning technique and the compact nature of the device enables a compact spectral analysis system. The resulting spectral information can be analyzed visually or electronically, for example, by comparing a current image with previously acquired spectral information.

The control module 217 in FIG. 2 generates the electronic signals to mode lock both laser diodes 201 and 210 and provides a signal representing the frequency off set between them to the processing module 216. This signal represents the coherence phase relationship between the reference and probe signals. This allows the processing module 216 to determine from what depth in the target the detected interferometric signal was reflected or scattered.

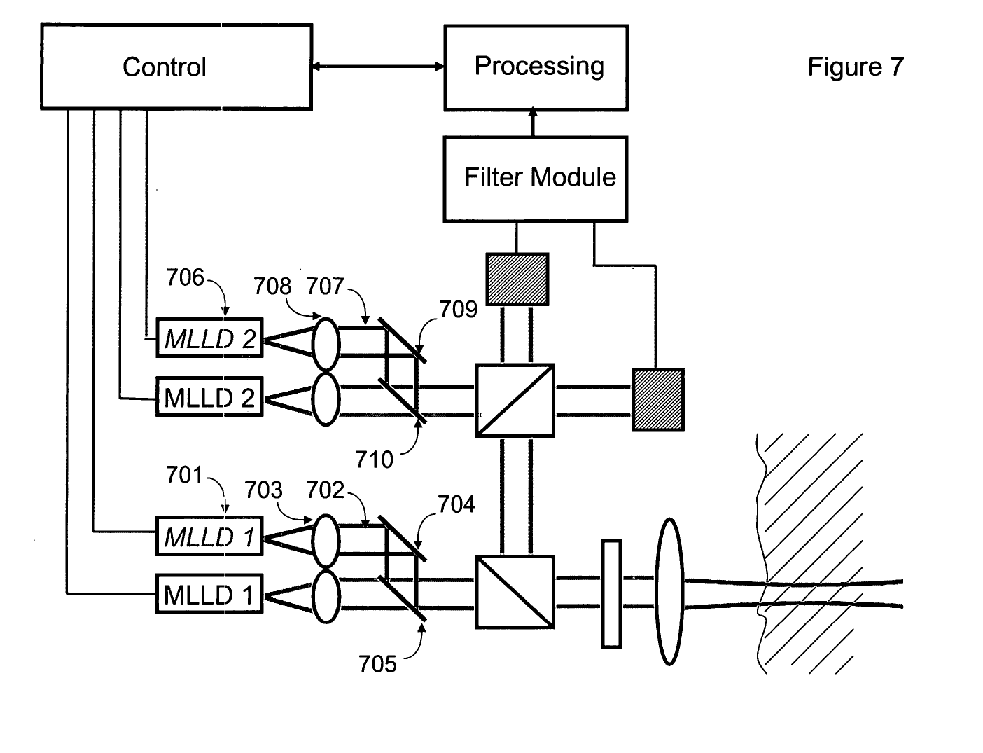

An alternative embodiment, illustrated in FIG. 7, has two sets of mode locked lasers with the second set operating at a wavelength range that is substantially different from the wavelength range of the first set. In addition to the system illustrated in FIG. 2, this embodiment has a second probe mode locked laser diode 701, whose output 702 is collimated by the lens 703 and combined with the output of the other probe mode locked laser by means of reflective elements 704 and 705. Similarly, a second reference mode locked laser diode 706, whose output 707 is collimated by the lens 708 and combined with the output of the other reference mode locked laser by means of reflective elements 709 and 710.

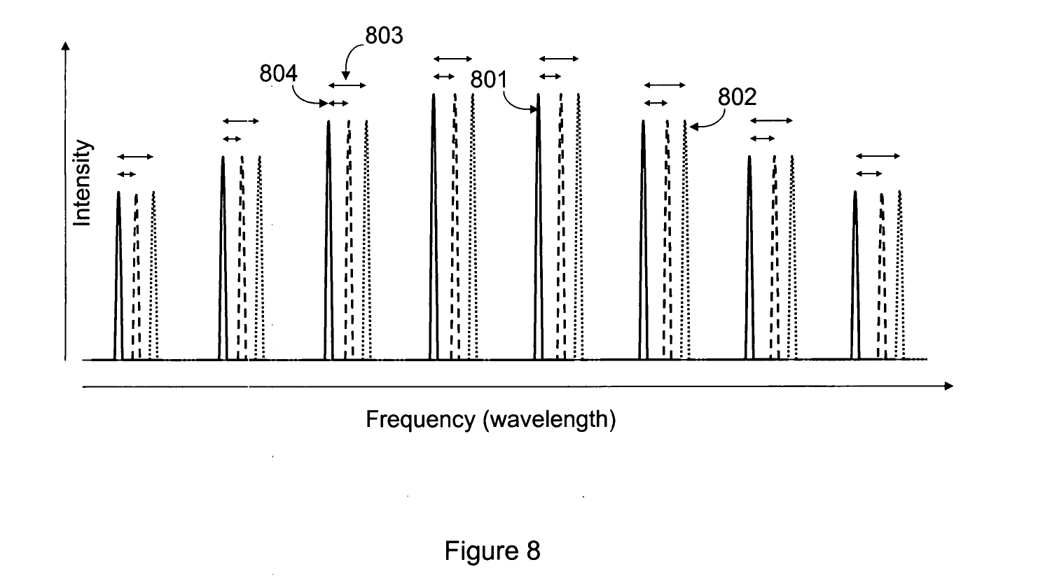

The second probe wavelengths have a high frequency offset from their corresponding reference wavelengths that is substantially different from the high frequency offset of the first probe and reference wavelengths. A suitable offset, compatible with the earlier example would be 4 GHz. The wavelength sets are illustrated in FIG. 8, where the second probe set is in solid lines, one of which is 801 and the second reference set is in dotted lines, one of which is 802. The set of dashed lines is included to indicate the relative frequency of the first reference set.

A typical frequency offset 803 of a pair if second probe and reference wavelengths, in the example, would be 4 GHz plus twice the low frequency offset (which could be the same as for the first set). This is substantially different from the corresponding frequency offset 804 of the first set, which was 2 GHz plus twice the low frequency offset.

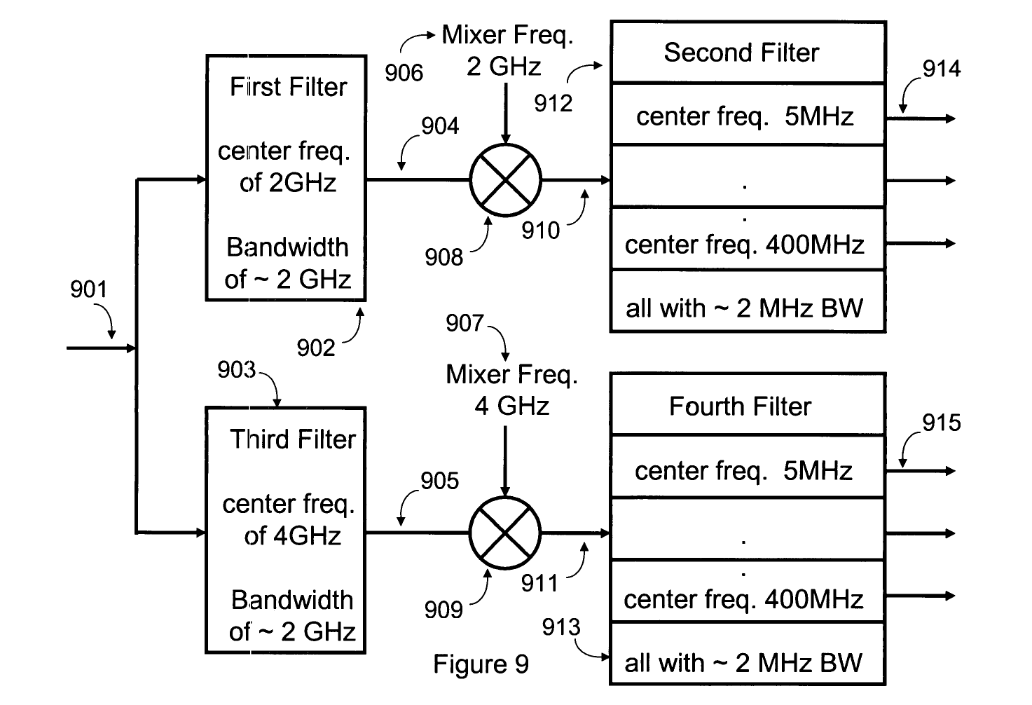

Such an arrangement allows all spectral information to be separated out in the electronic domain. An example of a possible filter arrangement for this embodiment is illustrated in FIG. 9 where the combined spectral information signal 901 are first separated by two filters 902 and 903 centered on 2 GHz and 4 GHz respectively. The outputs of these 904 and 905 are mixed with the signals 906 and 907 by mixers 908 and 909 to output base band signals 910 and 911 which are applied to two banks of filters 912 and 913 to provide spectrally separated information.

The outputs of the filters, the first of which for one set being 914, and for the other set being 915, are electronically processed by an electronic processing module 216 of FIG. 2. An electronic control module 217 controls the mode locked operation of the laser diodes 201 and 210 and also provides timing information to the processing module 215. The processing module combines this timing information with the detected filtered interference signals to compute spectral profiles of the target, and constitute a one dimensional spectral scan of the target.

The control and processing modules are similar to the preferred embodiment and enable spectral analysis of the target but, in this embodiment, at more than one wavelength range. As with the first embodiment, the spectral information is separated in the electronic domain, it may be correlated with depth related information from within the target, and the depth scanning mechanism requires no moving parts.

It is understood that the above description is intended to be illustrative and not restrictive. Many of the features have functional equivalents that are intended to be included in the invention as being taught.

For example, the mode locked laser could be optically pumped, it could be a solid state laser, such as a Cr:LiSAF laser optically pumped by a diode laser and it could be passively mode locked by a Kerr lens or a semiconductor saturable absorber mirror.

The electronic filtering could involve more sophisticated standard techniques, such as super heterodyne techniques. The frequency offsets could correspond to standard TV or radio channel spacing, to avail of existing low cost consumer components. Filtering could include using tunable filters, such as 6 MHz digitally tunable filters as used in standard TV channel selectors. A set of such tunable filters could be used to analyze the relative strength of a set of spectral ranges. This would allow a simpler filtering system that could be programmable to analyze the target specific spectral signatures.

The different wavelength ranges could first be separated optically, to allow more channels per wavelength range. More than two sets of mode locked lasers could be used to further extend the spectral range of spectral analysis.

In another example, at least part of the probe signal that is transmitted through the target could be captured and directed to the combining element 108 of FIG. 1, by means of other optics. For purposes of this invention, such a captured transmitted signal is included in the terms captured returned signal and returned signal.

The technique is not restricted to discrete coherent optical signals. The invention could also be implemented using generators of discrete coherent acoustic signals or using discrete coherent RF signals. This invention includes using discrete coherent signals of any type.

Other examples will be apparent to persons skilled in the art. The scope of this invention should therefore not be determined with reference to the above description, but instead should be determined with reference to the appended claims, along with the full scope of equivalents to which such claims are entitled.

1. A method for spectral analysis of a target, the method comprising:
generating at least one probe repetitive signal which is a probe signal;
applying at least part of said probe signal to the target to be analyzed;
capturing at least part of said probe signal returned from the target to form a captured returned signal which is a returned signal;
generating at least one reference repetitive signal which is a reference signal;
combining the returned signal with at least one reference signal;
modifying the coherence phase relationship between the returned signal and the reference signal;
detecting an interference signal between the returned signal and the reference signal to form a detected interference signal;
electronically filtering components of the detected interference signal; and
generating a spectral profile of the target.

2. The method of claim 1, wherein the probe repetitive signal is an optical signal generated by a first mode locked laser.

3. The method of claim 2, wherein the mode locked laser is a mode locked semiconductor laser.

4. The method of claim 1, wherein part of the probe repetitive signal is returned by scattering properties of the target.

5. The method of claim 1, wherein part of the probe repetitive signal is returned by transmitting properties of the target.

6. The method of claim 1, wherein the returned signal is combined with a reference signal generated by a second mode locked laser.

7. The method of claim 6, wherein the second mode locked laser has a mode locking frequency offset from the first mode locked laser.

8. The method of claim 7, wherein the second mode locked laser has wavelength values offset from the wavelength values of the first mode locked laser by an offset that is substantially different for all corresponding wavelengths.

9. The method of claim 7, wherein the second mode locked laser has wavelength values offset from the corresponding wavelength values of the first mode locked laser by an offsets that are integer multiples of the frequency offset between the first and second mode locked lasers.

10. The method of claim 1, wherein the coherence phase relationship between the returned signal and the reference signal is modified by means of the frequency offset between the first and second mode locked lasers.

11. The method of claim 1, wherein the returned signal and the reference signal are combined interferometrically.

12. The method of claim 1, wherein the interference signal between the returned and reference signals is detected by means of at least one opto-electronic detectors.

13. The method of claim 1, wherein the detected interference signals are electronically filtered.

14. The method of claim 13, wherein the detected interference signals are electronically filtered by filters centered on frequencies related to the frequency differences of corresponding wavelengths of the returned and reference signals.

15. The method of claim 13, wherein the detected interference signals are electronically filtered by filters offset from each other by an amount related to the frequency offset between the first and second mode locked lasers.

16. The method of claim 13, wherein the detected interference signals are electronically filtered by programmable filters.

17. The method of claim 1, wherein the probe repetitive signal is applied successively to multiple entry points of the target to be analyzed.

18. The method of claim 1, wherein a repetitive signal is a set of acoustic signals.

19. The method of claim 1, wherein a repetitive signal is a set of RF signals.

20. A system for spectral analysis of a target comprising:
generating at least one probe repetitive signal which is a probe signal;
applying at least part of said probe signal to the target to be analyzed;
capturing at least part of said probe signal returned from the target to form a captured returned signal which is a returned signal;
generating at least one reference repetitive signal which is a reference signal;
combining the returned signal with at least one reference signal;
modifying the coherence phase relationship between the returned signal and the reference signal;
detecting an interference signal between the returned signal and the reference signal to form a detected interference signal;
electronically filtering components of the detected interference signal; and
generating a spectral profile of the target.

21. An apparatus for spectral analysis of a target comprising:
means for generating at least one probe repetitive signal which is a probe signal;
means for applying at least part of said probe signal to the target to be analyzed;
means for capturing at least part of said probe signal returned from the target to form a captured returned signal which is a returned signal;
means for generating at least one reference repetitive signal which is a reference signal;
means for combining the returned signal with at least one reference signal;
means for modifying the coherence phase relationship between the returned signal and the reference signal;
means for detecting an interference signal between the returned signal and the reference signal to form a detected interference signal;
means for electronically filtering components of the detected interference signal; and
means for generating a spectral profile of the target.

22. The apparatus of claim 21, wherein the probe repetitive signal is an optical signal generated by a first mode locked laser.

23. The apparatus of claim 22, wherein the mode locked laser is a mode locked semiconductor laser.

24. The apparatus of claim 21, wherein part of the probe repetitive signal is returned by scattering properties of the target.

25. The apparatus of claim 21, wherein part of the probe repetitive signal is returned by transmitting properties of the target.

26. The apparatus of claim 21, wherein the returned signal is combined with a reference signal generated by a second mode locked laser.

27. The apparatus of claim 26, wherein the second mode locked laser has a mode locking frequency offset from the first mode locked laser.

28. The apparatus of claim 27, wherein the second mode locked laser has wavelength values offset from the wavelength values of the first mode locked laser by an offset that is substantially different for all corresponding wavelengths.

29. The apparatus of claim 27, wherein the second mode locked laser has wavelength values offset from the corresponding wavelength values of the first mode locked laser by an offsets that are integer multiples of the frequency offset between the first and second mode locked lasers.

30. The apparatus of claim 21, wherein the coherence phase relationship between the returned signal and the reference signal is modified by means of the frequency offset between the first and second mode locked lasers.

31. The apparatus of claim 21, wherein the returned signal and the reference signal are combined interferometrically.

32. The apparatus of claim 21, wherein the interference signal between the returned and reference signals is detected by means of at least one opto-electronic detectors.

33. The apparatus of claim 21, wherein the detected interference signals are electronically filtered.

34. The apparatus of claim 33, wherein the detected interference signals are electronically filtered by filters centered on frequencies related to the frequency differences of corresponding wavelengths of the returned and reference signals.

35. The apparatus of claim 33, wherein the detected interference signals are electronically filtered by filters offset from each other by an amount related to the frequency offset between the first and second mode locked lasers.

36. The apparatus of claim 33, wherein the detected interference signals are electronically filtered by programmable filters.

37. The apparatus of claim 21, wherein the probe repetitive signal is applied successively to multiple entry points of the target to be analyzed.

38. The apparatus of claim 21, wherein a repetitive signal is a set of acoustic signals.

39. The apparatus of claim 21, wherein a repetitive signal is a set of RF signals.
